(19) United States
(12) Patent Application Publication
(10) Pub. No.: US 2021/0383686 A1
(43) Pub. Date: Dec. 9, 2021

(54) ROADSIDE COMPUTING SYSTEM FOR PREDICTING ROAD USER TRAJECTORY AND ASSESSING TRAVEL RISK

(71) Applicant: DENSO International America, Inc., Southfield, MI (US)

(72) Inventors: Yunfei XU, Milpitas, CA (US); Ravi AKELLA, San Jose, CA (US); Haris VOLOS, Sunnyvale, CA (US)

(73) Assignee: DENSO International America, Inc., Southfield, MI (US)

(21) Appl. No.: 17/216,254

(22) Filed: Mar. 29, 2021

Related U.S. Application Data
(60) Provisional application No. 63/035,356, filed on Jun. 5, 2020.

(51) Int. Cl. G08G 1/01

(52) U.S. Cl. CPC G08G 1/0133; G08G 1/0116; G08G 1/0141

(57) ABSTRACT

A roadside computing (RSC) system associated with a roadway obtains, a position of a connected road user. The RSC system is configured to identify at least one road user based on sensor data from one or more roadside sensors, determine a position of the at least one road user identified based on the sensor data, track by the RSC system, the position of the road user traveling on the roadway, determine a predicted trajectory of the road user based on the tracked position of the road user and a trajectory prediction model, and transmit information related to the predicted trajectory to the computing device associated with the connected road user.

### CROSS-REFERENCE TO RELATED APPLICATION

This application is a U.S. Patent Application, which claims priority to and the benefit of U.S. Provisional Patent Application No. 63/035,356 filed on Jun. 5, 2020. The disclosure of the above application is incorporated herein by reference.

### FIELD

The present disclosure relates to roadside systems and, more particularly, to roadside systems that monitor traffic of road users.

### BACKGROUND

The statements in this section merely provide background information related to the present disclosure and may not constitute prior art.

A roadway may include various types of road users (e.g., vehicles, pedestrians, bicyclists, among others) traveling to and from various locations. A roadside computing system (i.e., a roadside unit) is typically provided to monitor road users traveling along the roadway and can be configured to communicate with road users via a wireless communication link. The roadside computing system can be configured to provide information to road users such as information related to traffic incidents. However, such roadside computing systems may not provide comprehensive information related to the overall travel characteristics of the roadway.

### SUMMARY

This section provides a general summary of the disclosure and is not a comprehensive disclosure of its full scope or all of its features.

In one form, the present disclosure is directed to a method that includes obtaining, by a roadside computing (RSC) system associated with a roadway, a position of a connected road user provided in a message from the connected road user. The connected road user is communicatively coupled to the RSC system via a computing device associated with the connected road user. The method further includes identifying, by the RSC system, at least one road user based on sensor data from one or more roadside sensors, where the at least one road user includes the connected road user, determining, by the RSC system, a position of the at least one road user identified based on the sensor data, tracking, by the RSC system, the position of the road user traveling on the roadway, determining, by the RSC system, a predicted trajectory of the road user based on the tracked position of the road user and a trajectory prediction model, and transmitting, by the RSC system, information related to the predicted trajectory to the computing device associated with the connected road user.

In some variations, the method further includes obtaining, by the RSC system, supplemental information, where the supplemental information provides travel characteristics of the roadway, and the predicted trajectory is further determined based on the supplemental information.

In some variations, the method further includes assessing, by the RSC system, travel risk of the road user based on the predicted trajectory, the supplemental information, or a combination thereof.

In some variations, assessing travel risk further includes determining, by the RSC system, whether a travel incident is possible based on the predicted trajectory, the supplemental information, or a combination thereof.

In some variations, the travel incident includes a potential collision of a given road user with an object identified along the predicted trajectory, a transition of a traffic management device while the given road user is travelling, an abrupt action by the given road user due to a travel impediment, or a combination thereof.

In some variations, the method further includes transmitting, by the RSC system, at least one of: the predicted trajectory of the object to the given road user in response to the travel incident being the potential collision and the object being another road user; a notification to the given road user that the traffic management device is going to transition; and a notification to the given road user regarding the travel impediment.

In some variations, the supplemental information includes weather characteristics, real-time traffic information, status of a traffic management device, road characteristics, or a combination thereof.

In some variations, a plurality of positions of the road user is tracked.

In some variations, the roadside sensor includes a multidimensional camera, a multidimensional scanner, a radar, an infrared sensor, a LIDAR, or a combination thereof.

In some variations, a plurality of the road users are identified and the predicted trajectory is determined for each of the plurality of the road users.

In some variations, the road user includes an unconnected road user, where the unconnected road user is communicatively uncoupled to the RSC system.

In one form, the present disclosure is directed to a roadside computing system that includes a wireless communication, one or more roadside sensor to obtain sensor data indicating at least one road user, a processor; and a nontransitory computer-readable medium. The wireless communication device includes a transceiver and is configured to communicate with a connected road user. The wireless communication device receives a message from the connected road user, and the message includes a position of the connected road user. The nontransitory computer-readable medium includes instructions that are executable by the processor, and the instructions include: identifying at least one road user based on the sensor data from the one or more roadside sensors, wherein the at least one road user includes the connected road user and an unconnected road user, where the unconnected road user is communicatively uncoupled to the RSC system; determining a position of the at least one road user identified based on the sensor data; tracking the position of the road user traveling on a roadway; determining a predicted trajectory of the road user based on the tracked position of the road user and a trajectory prediction model; and assessing a travel risk of the at least one road user based on the predicted trajectory wherein the wireless communication device is configured to transmit information related to the predicted trajectory to a computing device associated with the connected road user.

In some variations, the wireless communication device is communicatively coupled to one or more supplemental data sources to obtain supplemental information, where the supplemental information provides travel characteristics of the roadway, and the predicted trajectory is further determined based on the supplemental information and the travel risk is further assessed based on the supplemental information.

In some variations, the instructions for assessing travel risk further includes determining whether a travel incident is possible based on the predicted trajectory, the supplemental information, or a combination thereof.

In some variations, the travel incident includes a potential collision of a given road user with an object identified along the predicted trajectory, an abrupt action by the given road user due to a travel impediment, a transition of a traffic management device while the given road user is travelling, or a combination thereof.

In some variations, the wireless computing device is configured to transmit at least one of: the predicted trajectory of the object to the given road user in response to the travel incident being the potential collision and the object being another road user; a notification to the given road user that the traffic management device is going to transition; and a notification to the given road user regarding the travel impediment.

In some variations, a plurality of positions of the road user is tracked.

In some variations, the roadside sensor includes a multidimensional camera, a multidimensional scanner, a radar, an infrared sensor, a LIDAR, or a combination thereof.

In one form, the present disclosure is directed to a method that includes obtaining, by a roadside computing (RSC) system associated with a roadway, a position of a connected road user provided in a message from the connected road user. The connected road user is communicatively coupled to the RSC system via a computing device associated with the connected road user. The method further includes identifying, by the RSC system, at least one road user of the roadway based on sensor data from one or more roadside sensors, determining, by the RSC system, position of the at least one road user, and obtaining, by the RSC system, supplemental information that provides travel characteristics of the roadway. The supplemental information includes weather characteristics, real-time traffic information, status of a traffic management device, road characteristics, or a combination thereof. The method further includes tracking, by the RSC system, a plurality of positions of the road user traveling the roadway, determining, by the RSC system, a predicted trajectory of the road user based on a trajectory prediction model, the tracked position of the road user, and the supplemental information, and assessing, by the RSC system, a travel risk of the road user based on the predicted trajectory, the supplemental information, or a combination thereof. The method further includes transmitting, by the RSC system, information related to the predicted trajectory to a computing device associated with a connected road user, where the at least one road user includes the connected road user, and the connected road user is communicatively coupled to the RSC system.

In some variations, assessing travel risk further includes determining, by the RSC system, whether a traffic incident is possible based on the predicted trajectory, the supplemental information, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1A and 1B illustrate a highway roadway and a four-way intersection roadway, respectively, according to the present disclosure;

FIG. 2 is a block diagram of a system having a roadside computing (RSC) system according to the present disclosure;

FIG. 3 is a block diagram of the RSC system according to the present disclosure;

FIG. 4 is an example of a travel prediction model according to the present disclosure;

FIG. 5 is an example of predicted trajectories based on the travel prediction model according to the present disclosure; and

FIG. 6 is a flowchart of a traffic monitoring routine according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A roadside computing (RSC) system may be configured and employed as an edge computing device for road users traveling along a roadway associated with the RSC system. For example, the RSC system may receive a message from a fully autonomous vehicle, where the message provides dynamic characteristics of the vehicle, such as speed, position, and/or travel direction. Based on the dynamic characteristics, the RSC system determines and transmits a predicted trajectory for the vehicle. However, such predictions may be performed based only on the data from the autonomous vehicle.

In one form, the RSC system of the present disclosure provides a comprehensive view of the roadway taking into consideration road users that are communicatively connected and not connected to the RSC system. The RSC system may further employ contextual data related to the travel characteristics of the roadway such as weather, construction, real-time traffic, among other data. Based on these inputs, the RSC system predicts trajectories of the road users and may further assess travel risk to the road users. The RSC system may then transmit information related to the predicted trajectories to respective connected road users such as, but not limited to: the predicted trajectory for a respective road user, a notification regarding the travel risk to the respective roader user, and/or predicted trajectory of a neighboring road user based on the travel risk.

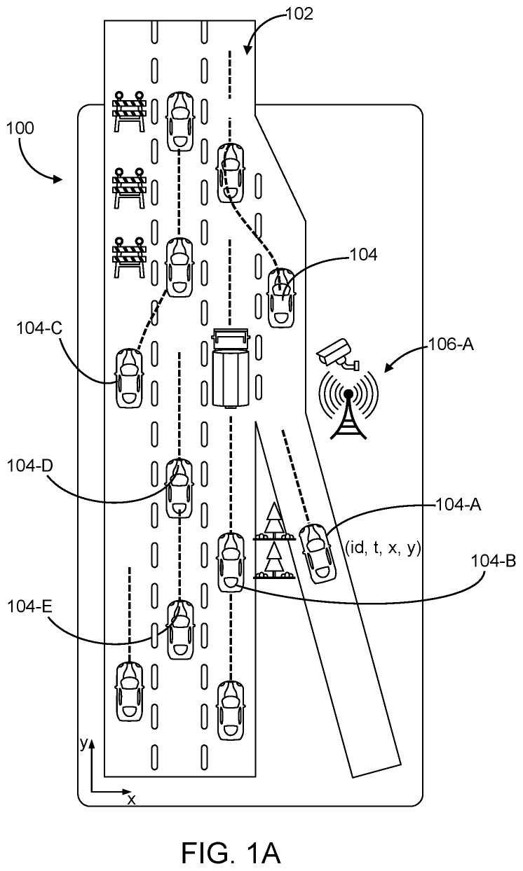

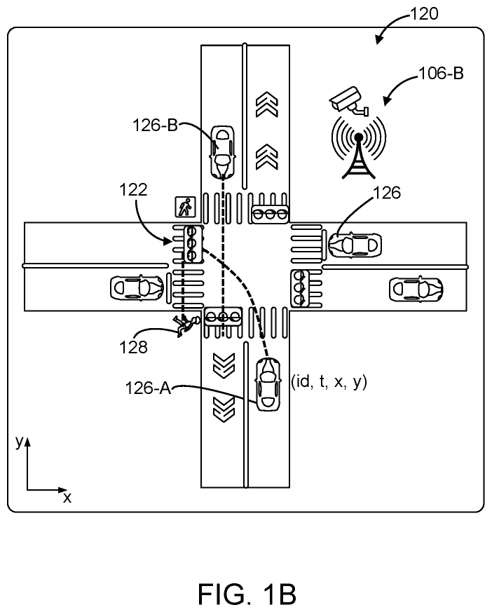

Referring to FIG. 1A, an example roadway 100 is provided as a highway having multiple travel lanes 102 upon which vehicles 104 are driving along. A roadside computing (RSC) system 106-A of the present disclosure is configured to predict trajectories of the vehicles using a trajectory prediction model and a position(s) of the vehicles 104 traveling along the roadway 100. Using the predicted trajectory, the RSC system 106-A is further configured to assess a travel risk to determine if the predicted trajectory is safe or in other words, whether the predicted trajectory is at risk of travel incident such as but not limited to: collision with an object including another vehicle, an abrupt stop of a leading vehicle, and a vehicle swerving into a travel lane of a respective vehicle. The RSC system 106-A transmits information related to the predicted trajectory, the travel risk, or combination thereof to a respective vehicle 104.

The RSC system of the present disclosure is also applicable in environments having pedestrians and vehicles. For example, referring to FIG. 1B, an RSC system 106-B is provided about a roadway 120 having four-way intersection with pedestrian crosswalks and traffic management devices 122 (e.g., traffic lights). The roadway 120 is traveled by different types of users such as but not limited to, vehicles 126 and pedestrians 128. In this example, the RSC system 106-B is configured to not only determine a predicted trajectory and travel risk of the vehicles 126 but also the pedestrians 128.

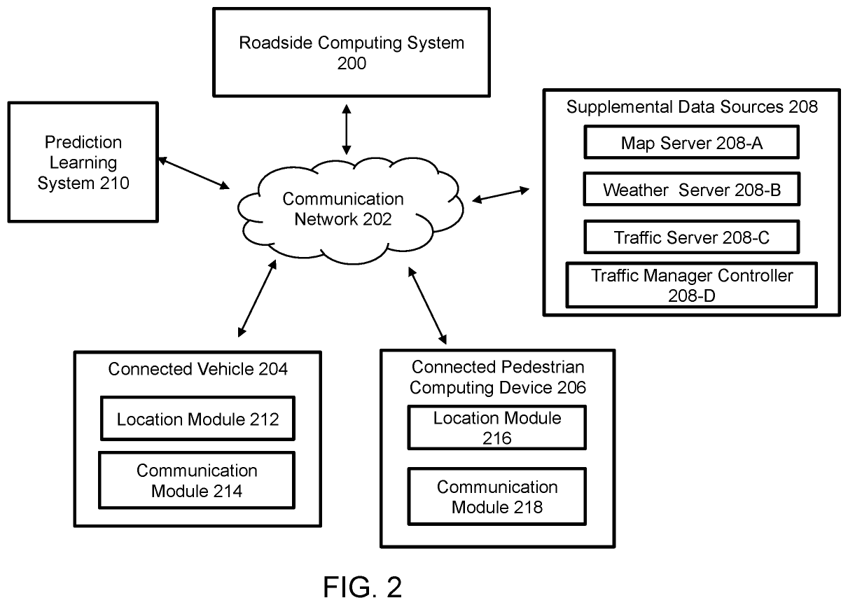

Referring to FIG. 2, in one form, an RSC system 200 is configured to communicatively couple to various devices via a communication network 202. More particularly, the communication network 202 is configured to provide device-to-device communication, which incorporates vehicle-to-infrastructure communication, infrastructure-to-infrastructure, and infrastructure-to-pedestrian communication. In one form, the communication network 202 may encompass dedicated short-range communication (DSRC), cellular communication (e.g., 3GPP and 5G), and/or satellite communication. In one form, via the communication network, the RSC system 200 is in communication with road users (e.g., a connected vehicle 204 and a pedestrian computing device 206), one or more supplemental data sources 208 and a prediction learning system 210.

In the following, a road user that is communicatively connected to the RSC system 200 is referred to as a connected road user and a road user not in communication with the RSC system 200 is provided as an unconnected road user. In one form, the connected road user includes a connected vehicle 204 and a pedestrian connected by way of a computing device (i.e., a pedestrian computing device 206).

The connected vehicle 204 may be a fully autonomous vehicle, partial-autonomous vehicles, and/or non-autonomous vehicles, and is configured to exchange data with the RSC system 200 to obtain information related to the predicted trajectory determined for the connected vehicle. Among other components, the connected vehicle includes a location module 212 and a communication module 214. The location module 212 is configured to track a position of the connected vehicle 204 based on one or more positional sensors provided with the vehicle 204 (e.g., a Global Navigation Satellite System (GNSS) receiver, accelerometer, etc.). The communication module 214 is configured to exchange messages with the RSC system 200 via the communication network 202 and may include various components such as a transceiver (not shown) and a processor configured to generate messages to be transmitted and process messages received. In one form, communication module 214 is configured to generate and transmit messages that include vehicle identification used to identify the connected vehicle and dynamic characteristics of the connected vehicle. The dynamic characteristics may include, but are not limited to, position, speed, and/or heading of the connected vehicle. The message may include other information such as a timestamp, and should not be limited to the examples provided. In one variation, the message may be provided as basic safety messages as provided in vehicle-to-everything (V2X) communication.

Similar to the connected vehicle 204, the pedestrian computing device 206 is configured to communicate information to the RSC system 200. Accordingly, among other components, the pedestrian computing device 206 is configured to include a location module 216 and a communication module 218. The location module 216 is configured to track a position of the pedestrian computing device 206 and thus, the pedestrian based on data from a positional sensor (e.g., GPS, accelerometers, among others). Similar to the communication module 214 of the connected vehicle, the communication module 218 is configured to exchange messages with the RSC system 200 via the communication network 202 and may include various components such as a transceiver (not shown) and a processor configured to generate messages to be transmitted and process messages received. The messages may include information indicative of pedestrian identification that is used to identify the pedestrian computing device 206 and/or dynamic characteristics that includes, for example, position, speed, and/or heading of the pedestrian computing device 206. In one variation, the message may be provided as personal safety message as provided in pedestrian-to-infrastructure communication.

The supplemental data sources provide supplemental information indicative of travel characteristics of the roadway, where the travel characteristics may influence the trajectory and/or travel risk of a road user. The supplemental information may include, but is not limited to, weather characteristics, real-time traffic information, status of a traffic management device, and/or road characteristics.

In one form, supplemental data sources may include, but is not limited to, a map server 208-A configured to manage maps of one or more roadways to provide road characteristics of the roadway (e.g., curvature, intersections, incline, decline, among other characteristics); a weather server 208-B configured to provide weather characteristics or in other words, weather conditions (e.g., foggy condition, rain, sunny, snow, among other conditions) related to a location of the RCS system 200; a traffic server 208-C configured to provide traffic information (such as travel time, accidents, road closure, construction information, among other traffic related information; and if applicable, a traffic manager controller 208-D configured to provide information related to a traffic signal provided about the roadway 100 associated with the RSC system 200.

As described further herein, the prediction learning system 210 is configured to develop a trajectory prediction model employed by the RSC system 200 to predict a trajectory of a road user. In one form, the prediction learning system 210 is configured to have a neural network with historical dataset for training the neural network and generating the trajectory prediction model.

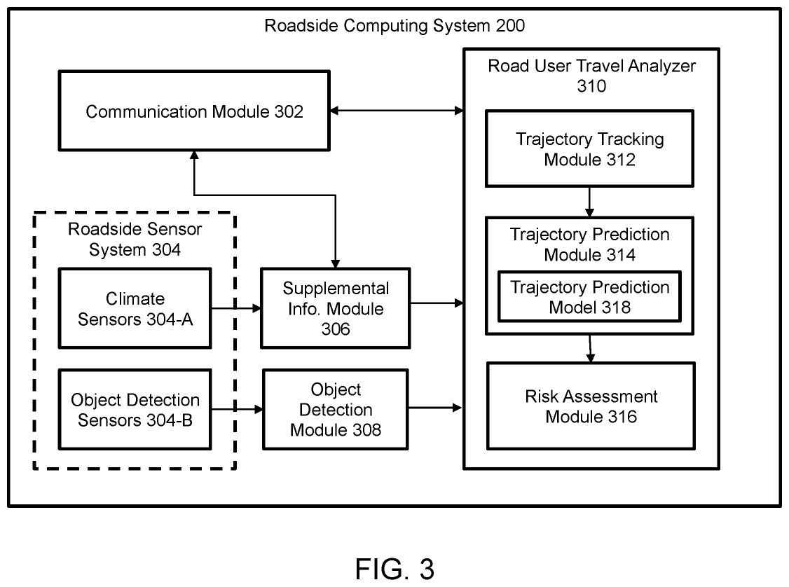

As described herein, the RSC system 200 is configured to predict a trajectory (i.e., a predicted trajectory) of a road user and further provides information related to a predicted trajectory to a connected road user, and specifically to the computing device associated with the connected road user. In one form, the RSC system 200 can be used for the RSC systems 106-A and 106-B of FIGS. 1A and 1B, respectively. Referring to FIG. 3, in one form, the RSC system 200 includes a communication module 302, a roadside sensor system 304, a supplemental information module 306, an object detection module 308, and a road user travel analyzer 310.

The communication module 302 is configured as an infrastructure-to-everything device to communicate with the connected vehicle(s) 204, the connected pedestrian computing device(s) 206, the supplemental data sources 208, and the prediction learning system 210 via the communication network. Accordingly, The communication module 302 may include one or more transceivers, radio circuits, amplifiers, modulation circuits, among others for communicating with various devices. The communication module 302 may be referenced as the infrastructure communication module 302 to distinguish from other communication modules described herein.

The roadside sensor system 304 includes one or more sensors to obtain sensor data used to monitor the roadway. In one form, the sensors includes weather sensors 304-A for detecting weather conditions such as visibility, precipitation, among other conditions, and object detections sensors 304-B used to identify road users. The object detection sensors 304-B include, but are not limited to, multidimensional cameras, multidimensional scanners, radar, infrared sensor and/or light detection and ranging sensor (LIDAR). In one form, the roadside sensor system 304 are configured to provide an aerial or birds-eye view of the roadway 100.

In one form, the supplemental information module 306 is configured to obtain supplemental information from the supplemental data sources 208 via the infrastructure communication module 302. In addition to the supplemental data sources 208, the supplemental information may also be provided by one or more sensors of the roadside sensor system 304. For example, the supplemental information module 306 may obtain supplemental information indicative of weather conditions from the weather sensors 304-A. The supplemental information is employed by the road user travel analyzer 310 as described below.

In one form, the object detection module 308 is configured to identify a road user of the roadway and determine one or more dynamic characteristics of the road user based on data from the object detection sensors. For example, using known image processing techniques, the object detection module 308 identifies the road user such as a vehicle. In another example, the object detection sensor(s) 304-B may emit a signal having predefined properties (e.g., frequency, waveform, amplitude, etc.), and receive a signal that is reflected by an object, such as a vehicle or a pedestrian. Using known methods, the object detection module 308 analyzes the signals transmitted and received to determine whether a moving object is present, and if so, determines one or more dynamic characteristics such a position based on data from the object detection sensors 304-B. In some variations, the object detection module 308 is configured to filter data/images to remove known objects (e.g., roadway barriers, traffic management devices, trees, building, etc.). With the object detection sensors 304-B and the object detection module 308, the RSC system 200 can independently track connected and unconnected road users. In addition, the system 200 detects objects not readily visible by a respective road user and thus, be able to assess travel risks based on unconnected road users.

The road user travel analyzer 310 is configured to track the position of road users, predict a trajectory of the road user, and/or assess a travel risk for the road user. In one form, the road user travel analyzer 310 is configured to include a trajectory tracking module 312, a trajectory prediction module 314, and a risk assessment module 316.

In one form, the trajectory tracking module 312 is configured to track position of one or more road users traveling within the detection area. More particularly, the trajectory tracking module 312 is configured to process messages from connected users to obtain the identification information and position of the connected road user. The trajectory tracking module 312 is also configured to obtain information (e.g., assigned identifier and position) related to one or more road users detected by the object detection module 308. In tracking the road user's position, the trajectory tracking module 312 stores multiple positions of the road user (x-positions where x is greater than 1) in, for example, a cache. Accordingly, the tracked position includes previous positions of the road user. The trajectory tracking module 312 is further configured to align data associated with road users to form a birds-eye view of the roadway. For example, the trajectory tracking module 312 determines if the road user detected by the object detection module 308 is a connected road user by aligning the position of the connected road user with that of the identified road user. Road users identified but not associated with a connect road user can be categorized as unconnected road users. The position of the connected and unconnected road users are further time aligned based on a time stamp of the sensor data and/or the message from the connected vehicle.

The trajectory prediction module 314 is configured to determine a predicted trajectory of the road user based on the tracked position of the road user and a trajectory prediction model 318. The trajectory prediction model 318 is developed using a neural network that is trained with historical datasets. As an example, referring to FIG. 2, the prediction learning system 210 is configured to include the neural network framework and historical database for training the neural network. Accordingly, the prediction learning system 210 includes servers, memory, processors, among other components for supporting and training the neural network.

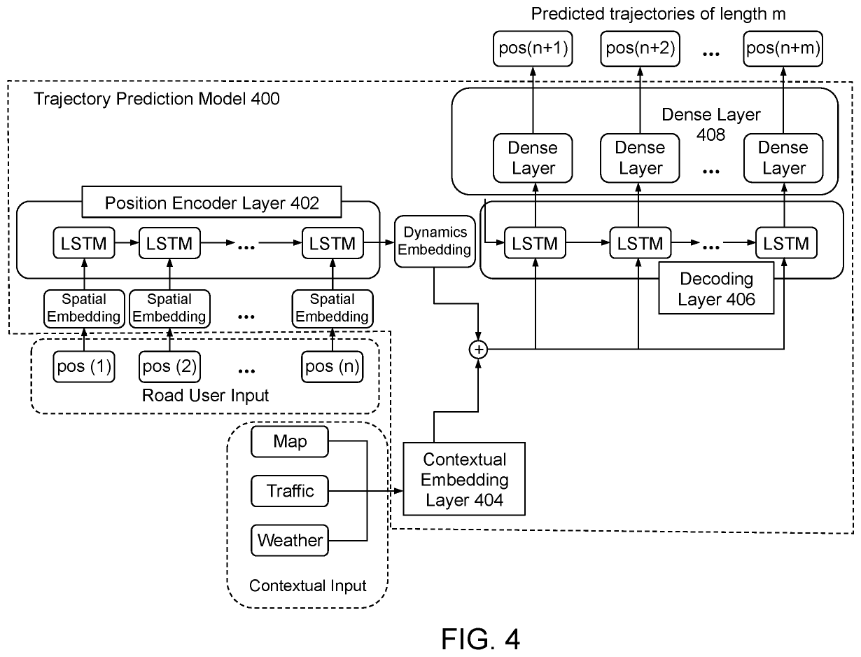

Referring to FIG. 4, an example of a trajectory prediction model 400 that can be employed as the trajectory prediction model 318 is provided. The model 400 employs a long short term memory (LSTM) recurrent neural network (RN N) and, in one form, includes a position encoder layer 402, a contextual embedding layer 404, a decoding layer 406, and a dense layer 408 that outputs the predicted trajectories of a road user. The input to the model 400 includes data indicative of the tracked position of the road users, and more particularly, includes a number associated with the road user (N), the length of the past trajectory (“n”) for the road user (e.g., 7 previous positions), and the dimension of the data (D) such as “2” for x-y position (i.e., coordinates). These inputs are collectively referenced to as road user inputs. The position encoder layer 402 is configured to generate a dynamic embedding that summarizes the dynamic behavior of the road user(s) based on the respective road user input. The dynamic embedding is provided as a fixed size vector and is referred to as a user dynamic vector.

The model 400 also receives contextual input in the way of the supplemental information obtained, such as map information, traffic information, and weather, among others. The contextual embedding layer 404 compresses the contextual input to generate a vector that is provided to the decoding layer 406 with the user dynamic vector(s). The decoding layer 406 is configured to determine the predicted trajectory for the road user(s) based on a learned association of the input to correct outputs. In one form, the predicted trajectories are of m-length or, in other words, m-number of predicted positions (e.g., 4 predicted positions, 5 predicted positions, etc.). The dense layer 408 is configured output the predicted trajectories. It should be understood that the LSTM based trajectory prediction model 400 is just one example neural network and that the trajectory prediction model of the present disclosure may be implemented using other types of neural network. In one variation, the model 400 takes into account possible interaction between road users. For example, if a given vehicle decelerates to change from a first lane to a second lane, the model 400 is configured to incorporate possible deceleration by other vehicles in the first lane and the second lane to accommodate the lane change of the given vehicle. In yet another variation, the trajectory prediction model 400 may be configured to analyze other dynamic characteristics of the road user, such as but not limited to travel direction, speed, acceleration, and/or deceleration (e.g., brake state to determine the predicted trajectories.

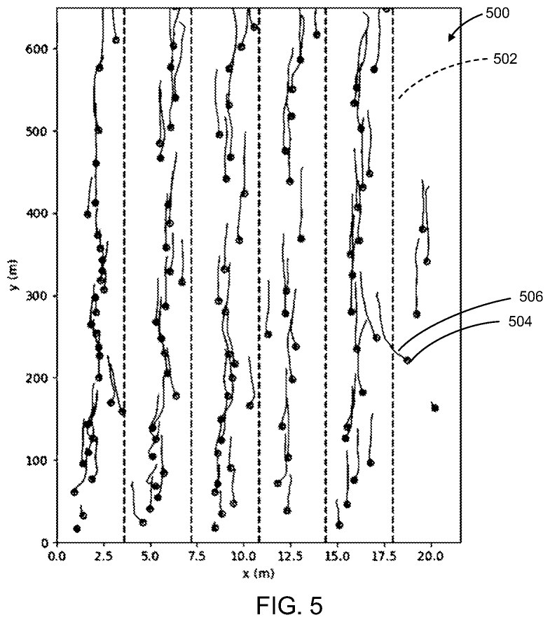

Referring to FIG. 5, an example of predicted trajectories is provided for all the road users traveling along a highway 500 as the roadway with dashed lines 502 representing lane boundaries. In the figure, +y represents the moving direction of the vehicles, each circle or dot 504 represents a road user (e.g., a vehicle), and a line 506 extending from the dot 504 represents a predicted trajectory of the road user, where the predicted trajectory is based on predicted positions of the road user within a selected time period (e.g., 5 seconds in future). With the data from connected road users and from the roadside sensor system 304, the RSC system 200 obtains a birds-eye view of the roadway and predicts the trajectory for all road users at the same time.

In one form, once predicted, the trajectory prediction module 314 is configured to transmit a respective predicted trajectory to a respective road user such as fully or partially autonomous vehicle. For example, an autonomous vehicle may request the predicted trajectory in the message transmitted to the RSC system 200 and use the predicted trajectory for planning its travel route.

Referring to FIG. 3, the risk assessment module 316 is configured to assess a travel risk of the road user(s) based on the predicted trajectory(ies), the supplemental information, or a combination thereof. In one form, when assessing the travel risk, the risk assessment module 316 is configured to determine whether a traffic incident is possible based on the predicted trajectory and/or the supplemental information. The traffic incident may include, but is not limited to: a potential collision with an object identified along the predicted trajectory, where the object may be another road user and/or an object; a pedestrian travel risk in which a pedestrian may still be traveling along a crosswalk when a traffic management device indicates no travel for pedestrian; and a possible abrupt action by a road user (e.g., swerving, stopping) causing other road users to react. The type of traffic incidents assessed by the risk assessment module 316 is based on the roadway associated with the RSC system 200. For example, if the roadway is a highway, the risk assessment module 316 may not include traffic incidents related to pedestrian crosswalks.

In one form, to perform the risk assessment, the risk assessment module 316 is configured to include a set of rules for identifying one or more traffic incidents. If any one of the traffic incidents is present, the risk assessment module 316 is configured to determine that a travel risk exists and may issue a notification via the infrastructure communication module 302. In another form, to assess the risk, the risk assessment module 316 is configured to include a travel risk model that is provided as an artificial intelligent (AI) based model that is trained to identify travel incidents based on historical data set including predicted trajectories and various supplemental information. It should be understood that the risk assessment module 316 may be configured in various suitable ways and should not be limited to the examples provided herein.

In an example application, the risk assessment module 316 is configured to determine whether the predicted trajectories of two road users appears to overlap or intersect at a given point in time. If so, the risk assessment module 316 determines that a collision may occur and thus, flags a travel risk for the road users. The risk assessment module 316 may issue a notification to the road user(s) involved in the potential travel incident. The computing device associated with the road user may then provide a warning message to a passenger of the vehicle or the pedestrian in response to receiving the notification. In the event the object is another road user, the predicted trajectory of the other road user may be transmitted to a respective road user having the potential collision when the respective road user is a fully or partially autonomous road user.

In another example, the risk assessment module 316 is configured to determine if the roadway includes travel impediments that can cause a road user to perform an abrupt action. Travel impediments may include lane closure(s), slippery road conditions, low visibility (e.g., foggy condition, snow fall, etc.), flooding, and/or blocked lane(s) due to an accident or disabled vehicle, among other impediments. If the projected trajectory of a respective road user indicates the road user will enter a closed lane or the road user is traveling at a high speed with slippery roads, the risk assessment module 316 determines that there is a travel risk for the road user and issues a notification if the road user is a connected vehicle. The risk assessment module 316 may also issue a notification to other road users in the vicinity of the respective road user, where the notification may indicate that the respective vehicle may perform an abrupt action such as swerve into their lane or abruptly stop. In yet another example, the road user is at a pedestrian crosswalk and the risk assessment module 316 determines that the predicted trajectory indicates that the road user will be in the middle of the crosswalk when the traffic management device for crosswalk will transition to a state prohibiting crossing. The risk assessment module 316 may determine there is a travel risk and issue a notification that informs the road user the traffic management device is about to transition between states. The risk assessment module 316 may be configured to provide different type of notifications and should not be limited to the examples provided herein.

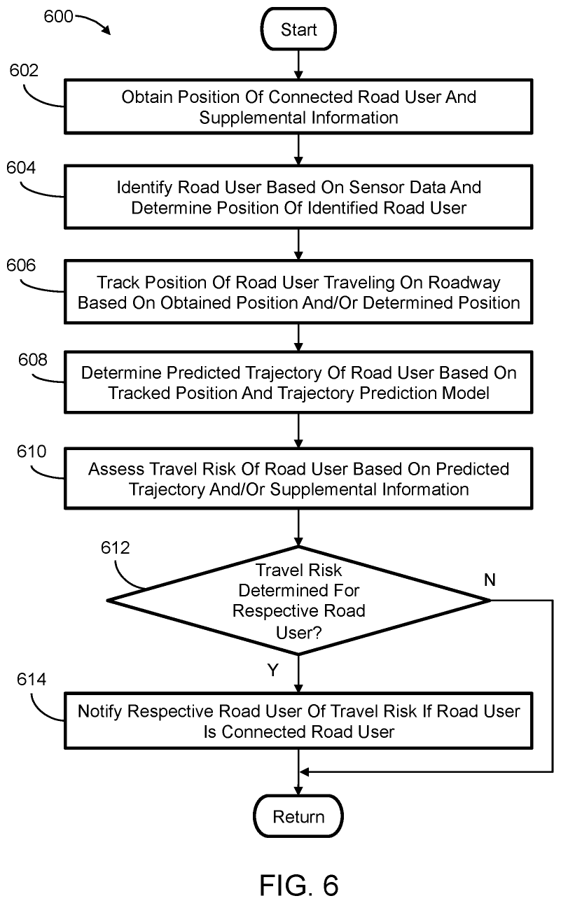

Referring to FIG. 6, an example traffic monitoring routine 600 performed by the RSC system 200 is provided. At 602, the RSC system 200 obtains position of a connected road user and supplemental information from supplemental data sources. At 604, using sensor data, the RSC system 200 identifies road user(s) and determines position of the identified road user(s). At 606, the RSC system 200 tracks position of the road user traveling on the roadway based on obtained position and/or determined position. At 608, the RSC system 200 determines a predicted trajectory of the road user(s) based on tracked position and the trajectory prediction model. At 610, the RSC system 200 assesses a travel risk of the road user(s) based on predicted trajectory and/or supplemental information. At 612, the RSC system 200 determines if a travel risk is present for a respective road user. If so, the RSC system 200 notifies the respective road user of the travel risk if the road user is a connected road user at 614.

Routine 600 is just one example routine of the RSC system 200, and other routines may be employed. For example, after predicting the trajectories, the RSC system 200 transmits the predicted trajectories to connected road users that requested the trajectories. In another example, RSC system 200 may periodically transmit saved positions, predicted trajectories, and/or assessed travel risks for one or more road users to the prediction learning system 210 for storage and learning of the trajectory prediction model.

An example application of the RSC system 200 is further described with regard to FIGS. 1A and 1B. Referring to FIG. 1A, a sensor, such as a camera, is mounted to monitor the roadway 100. The camera can record the scene and/or snapshots for the area, and the images are processed to identify the vehicles and determines vehicle position. Connected vehicles may transmit their current locations. The position obtained from the camera and from the connected vehicles are aligned with timestamp and fused by the RSC system 200 to obtain reliable past trajectories for all vehicles in the scene. The RSC system 200 next predicts future trajectories of the vehicles using contextual data including map data, local construction/incidents data, weather data, among others. A predicted trajectory for a given vehicle and those of neighboring vehicles may be transmitted the given vehicle for travel planning purposes. In addition, the predicted trajectories are employed for risk assessment, and the RSC system 200 notifies vehicles that are determined to be at a travel risk to inhibit or reduce impact of the travel incident. For example, vehicle 104-A and 104-B cannot see each other due to trees in between the roadway 100 and an on-ramp. The RSC system 200 of the present disclosure recognizes both vehicles and can provide warning to the vehicles 104-A and 104-B, which are in communication with the RSC system 200. In another example, vehicle 104-C may make an abrupt lane change toward the right due to the construction ahead, but vehicle 104-D may continue to move forward, which can lead to a collision between the two. Accordingly, the RSC system 200 may notify vehicle 104-D of vehicle-104-C possible abrupt lane change and may also further notify vehicle 104-E of possible braking by vehicle 104-D.

For the roadway 120 of FIG. 1B, the RSC system 200 may be equipped with multiple cameras to monitor the intersection. The cameras may be mounted at different locations and are not required to be mounted at the same location. The RSC system 200 is configured to align the images based on the timestamp to provide birds-eye or global views of the intersection. In this example, if vehicle 126-A is in the left lane to make a left turn, the vehicle 126-B is not aware of this causing an accident between the two vehicles 126-A and 126-B. In addition, the pedestrian 128 may be crossing the crosswalk at the same time. The RSC system 200 is able to predict trajectories and then determine a travel risk based on the trajectories for the vehicles 126-A, 126-B and the pedestrian 128. Based on the travel risk, the RSC system 200 can notify one or more of the vehicle 126-A, vehicle 126-B, and/or the pedestrian 128.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
obtaining, by a roadside computing (RSC) system associated with a roadway, a position of a connected road user provided in a message from the connected road user, wherein the connected road user is communicatively coupled to the RSC system via a computing device associated with the connected road user;
identifying, by the RSC system, at least one road user based on sensor data from one or more roadside sensors, wherein the at least one road user includes the connected road user;
determining, by the RSC system, a position of the at least one road user identified based on the sensor data;
tracking, by the RSC system, the position of the road user traveling on the roadway;
determining, by the RSC system, a predicted trajectory of the road user based on the tracked position of the road user and a trajectory prediction model; and
transmitting, by the RSC system, information related to the predicted trajectory to the computing device associated with the connected road user.

2. The method of claim 1 further comprising obtaining, by the RSC system, supplemental information, wherein the supplemental information provides travel characteristics of the roadway, and the predicted trajectory is further determined based on the supplemental information.

3. The method of claim 2 further comprising assessing, by the RSC system, travel risk of the road user based on the predicted trajectory, the supplemental information, or a combination thereof.

4. The method of claim 3, wherein assessing travel risk further comprises determining, by the RSC system, whether a travel incident is possible based on the predicted trajectory, the supplemental information, or a combination thereof.

5. The method of claim 4, wherein the travel incident includes a potential collision of a given road user with an object identified along the predicted trajectory, a transition of a traffic management device while the given road user is travelling, an abrupt action by the given road user due to a travel impediment, or a combination thereof.

6. The method of claim 5 further comprising transmitting, by the RSC system, at least one of:
the predicted trajectory of the object to the given road user in response to the travel incident being the potential collision and the object being another road user;
a notification to the given road user that the traffic management device is going to transition; and
a notification to the given road user regarding the travel impediment.

7. The method of claim 4, wherein the supplemental information includes weather characteristics, real-time traffic information, status of a traffic management device, road characteristics, or a combination thereof.

8. The method of claim 1, wherein a plurality of positions of the road user is tracked.

9. The method of claim 1, wherein the roadside sensor includes a multidimensional camera, a multidimensional scanner, a radar, an infrared sensor, a LIDAR, or a combination thereof.

10. The method of claim 1, wherein a plurality of the road users are identified and the predicted trajectory is determined for each of the plurality of the road users.

11. The method of claim 1, wherein the road user includes an unconnected road user, wherein the unconnected road user is communicatively uncoupled to the RSC system.

12. A roadside computing system comprising:
a wireless communication device including a transceiver and configured to communicate with a connected road user, wherein the wireless communication device receives a message from the connected road user, wherein the message includes a position of the connected road user;
one or more roadside sensor to obtain sensor data indicating at least one road user;
a processor; and
a nontransitory computer-readable medium including instructions that are executable by the processor, wherein the instructions include:
identifying at least one road user based on the sensor data from the one or more roadside sensors, wherein the at least one road user includes the connected road user and an unconnected road user, wherein the unconnected road user is communicatively uncoupled to the RSC system;
determining a position of the at least one road user identified based on the sensor data;
tracking the position of the road user traveling on a roadway;
determining a predicted trajectory of the road user based on the tracked position of the road user and a trajectory prediction model; and
assessing a travel risk of the at least one road user based on the predicted trajectory wherein the wireless communication device is configured to transmit information related to the predicted trajectory to a computing device associated with the connected road user.

13. The roadside computing system of claim 12, wherein the wireless communication device is communicatively coupled to one or more supplemental data sources to obtain supplemental information, wherein the supplemental information provides travel characteristics of the roadway, and the predicted trajectory is further determined based on the supplemental information and the travel risk is further assessed based on the supplemental information.

14. The roadside computing system of claim 13, wherein the instructions for assessing travel risk further includes determining whether a travel incident is possible based on the predicted trajectory, the supplemental information, or a combination thereof.

15. The roadside computing system of claim 14, wherein the travel incident includes a potential collision of a given road user with an object identified along the predicted trajectory, an abrupt action by the given road user due to a travel impediment, a transition of a traffic management device while the given road user is travelling, or a combination thereof.

16. The roadside computing system of claim 15, wherein the wireless computing device is configured to transmit at least one of:
the predicted trajectory of the object to the given road user in response to the travel incident being the potential collision and the object being another road user;
a notification to the given road user that the traffic management device is going to transition; and
a notification to the given road user regarding the travel impediment.

17. The roadside computing system of claim 11 a plurality of positions of the road user is tracked.

18. The roadside computing system of claim 11, wherein the roadside sensor includes a multidimensional camera, a multidimensional scanner, a radar, an infrared sensor, a LIDAR, or a combination thereof.

19. A method comprising:
obtaining, by a roadside computing (RSC) system associated with a roadway, a position of a connected road user provided in a message from the connected road user, wherein the connected road user is communicatively coupled to the RSC system via a computing device associated with the connected road user;
identifying, by the RSC system, at least one road user of the roadway based on sensor data from one or more roadside sensors;
determining, by the RSC system, position of the at least one road user;
obtaining, by the RSC system, supplemental information that provides travel characteristics of the roadway, wherein the supplemental information includes weather characteristics, real-time traffic information, status of a traffic management device, road characteristics, or a combination thereof;
tracking, by a RSC system, a plurality of positions of the road user traveling the roadway;
determining, by the RSC system, a predicted trajectory of the road user based on a trajectory prediction model, the tracked position of the road user, and the supplemental information;
assessing, by the RSC system, a travel risk of the road user based on the predicted trajectory, the supplemental information, or a combination thereof; and
transmitting, by the RSC system, information related to the predicted trajectory to a computing device associated with a connected road user, wherein the at least one road user includes the connected road user, wherein the connected road user is communicatively coupled to the RSC system.

20. The method of claim 19, wherein assessing travel risk further comprises determining, by the RSC system, whether a traffic incident is possible based on the predicted trajectory, the supplemental information, or a combination thereof.
